(19) United States
(12) Patent Application Publication
(10) Pub. No.: US 2025/0321342 A1
(43) Pub. Date: Oct. 16, 2025

(54) RADIATION DETECTOR AND RADIATION DETECTION DEVICE

(71) Applicant: HAMAMATSU PHOTONICS K.K., Hamamatsu-shi (JP)

(72) Inventors: Masahiro IIZUKA, Hamamatsu-shi (JP); Kazuki MATSUSHITA, Hamamatsu-shi (JP)

(73) Assignee: HAMAMATSU PHOTONICS K.K., Hamamatsu-shi (JP)

(21) Appl. No.: 19/172,844

(22) Filed: Apr. 8, 2025

(30) Foreign Application Priority Data
Apr. 10, 2024 (JP) 2024-063236

(51) Int. Cl. G01T 1/24

(52) U.S. Cl. CPC G01T 1/241

(57) ABSTRACT

A radiation detector includes a first portion including a first electrode portion, a semiconductor crystal portion, and a second electrode portion facing the first electrode portion in this order, and a second portion provided so as to surround a side surface of the semiconductor crystal portion. The second portion includes an insulating layer and a conductive layer in this order from the side surface of the semiconductor crystal portion, and the second electrode portion includes a plurality of pixel electrodes.

### TECHNICAL FIELD

The present disclosure relates to a radiation detector and a radiation detection device.

### BACKGROUND

In related art, a radiation detection device that detects radiation has been known. For example, a multichannel radiation detection device including a radiation detector having a common electrode for bias supply, a plurality of pixel electrodes for signal extraction, and a semiconductor crystal is known as the radiation detection device. In the multichannel radiation detection device, when radiation is incident on and interacts with a semiconductor crystal constituting a radiation detector in a state where a voltage is applied between the common electrode and the plurality of pixel electrodes, electrons and holes are generated in the semiconductor crystal. The number of electrons and holes to be generated increases in accordance with the intensity of the incident radiation. Each of the electrons and holes is accelerated by a voltage applied to the semiconductor crystal, and is detected as a current. A radiation spectrum (energy spectrum) is obtained from the magnitude of the detected current. For example, a semiconductor radiation detector described in Japanese Unexamined Patent Publication No. H9-92806 is known as the radiation detector having the plurality of pixel electrodes.

### SUMMARY

In the radiation detection device, a radiation detector having high energy resolution is required. It can be said that the energy resolution of the radiation detector is more excellent as a half width of a peak appearing in an energy spectrum is narrower. As a result of intensive studies, the present inventors have found that, in the multichannel radiation detector, a plurality of pixel electrodes positioned in an outer peripheral portion of the radiation detector, among the plurality of pixel electrodes, tends to have lower energy resolution than a plurality of pixel electrodes positioned in a central portion of the radiation detector.

Therefore, an object of one aspect of the present disclosure is to provide a multichannel radiation detector capable of improving energy resolution of a plurality of pixel electrodes positioned in an outer peripheral portion of a radiation detector. In addition, another aspect of the present disclosure is to provide a radiation detection device including the radiation detector.

The present disclosure includes, for example, the following [1] to [17].

[1] A radiation detector including
a first portion including a first electrode portion, a semiconductor crystal portion, and a second electrode portion facing the first electrode portion in this order, and
a second portion provided so as to surround a side surface of the semiconductor crystal portion,
in which the second portion includes an insulating layer and a conductive layer in this order from the side surface of the semiconductor crystal portion, and
the second electrode portion includes a plurality of pixel electrodes.

[2] The radiation detector according to [1], in which the semiconductor crystal portion has a semiconductor crystal containing at least one selected from the group consisting of thallium bromide, cadmium telluride, cadmium zinc telluride, and lead cesium tribromide.

[3] The radiation detector according to [1] or [2], in which the semiconductor crystal portion includes a plurality of semiconductor crystals.

[4] The radiation detector according to any one of [1] to [3], in which the insulating layer is disposed so as to cover entirety of the side surface of the semiconductor crystal portion.

[5] The radiation detector according to any one of [1] to [4], in which the insulating layer protrudes toward the first electrode portion with respect to a plane including a surface of the semiconductor crystal portion on the first electrode portion side.

[6] The radiation detector according to any one of [1] to [5], in which the insulating layer contains at least one selected from the group consisting of a silicone resin, an acrylic resin, a polyurethane resin, a polyimide resin, a polyolefin resin, and a fluororesin.

[7] The radiation detector according to any one of [1] to [6], in which a dielectric strength of the insulating layer in a thickness direction is 1.5 kV/mm or more.

[8] The radiation detector according to any one of [1] to [7], in which a dielectric strength of the insulating layer in a thickness direction is 19 kV/mm or more.

[9] The radiation detector according to any one of [1] to [8], in which a thickness of the insulating layer is 150 μm or less.

[10] The radiation detector according to any one of [1] to [9], in which a thickness of the insulating layer is 50 μm or less.

[11] The radiation detector according to any one of [1] to [10], in which the conductive layer contains at least one selected from the group consisting of copper, aluminum, gold, and an alloy containing the copper, aluminum, or gold.

[12] The radiation detector according to any one of [1] to [11], in which a thickness of the conductive layer is 50 nm or more.

[13] The radiation detector according to any one of [1] to [12], in which a thickness of the conductive layer is 150 nm or more.

[14] The radiation detector according to any one of [1] to [13], in which the second portion includes the insulating layer and the conductive layer in this order from a side surface of the first electrode portion.

[15] The radiation detector according to any one of [1] to [14], further including
a circuit unit electrically connected to each of the plurality of pixel electrodes,
in which the circuit unit processes information collected for each of the plurality of pixel electrodes and outputs the processed information as data.

[16] A radiation detection device including
the radiation detector according to any one of [1] to [15],
a power supply that applies a voltage to the radiation detector, and
a control unit electrically connected to the radiation detector and the power supply.

[17] The radiation detection device according to [16], in which a potential of the conductive layer is in a floating state.

According to the present disclosure, it is possible to provide a multichannel radiation detector capable of improving energy resolution of a plurality of pixel electrodes positioned in an outer peripheral portion of the radiation detector. In addition, according to the present disclosure, it is possible to provide a radiation detection device including the radiation detector.

### BRIEF DESCRIPTION OF THE DRAWINGS

FIG. 1 is a schematic sectional view illustrating an embodiment of a radiation detector;

FIG. 2 is a plan view of a plurality of pixel electrodes;

FIG. 3 is a plan view of a semiconductor crystal portion;

FIG. 4 is a graph representing results of energy spectra at one corner of pixel electrodes of Example 1 and Comparative Example 1;

FIG. 5 is a graph representing tendency of an average value of FWHM in Examples 1 to 4 and Comparative Example 1; and

FIG. 6 is a graph representing a relationship between a thickness of a conductive layer and an average value of the FWHM.

### DETAILED DESCRIPTION

Hereinafter, embodiments of the present disclosure will be described in detail. However, the present disclosure is not limited to the following embodiments.

In the present specification, a “plurality of pixel electrodes positioned in an outer peripheral portion” means pixel electrodes disposed along an outer periphery of an electrode portion in plan view of the electrode portion in which the plurality of pixel electrodes are present. In addition, in the present specification, the “plurality of pixel electrodes positioned in a central portion” means pixel electrodes disposed in a region of a half length from a center to an outer periphery of the electrode portion in plan view of the electrode portion in which the plurality of pixel electrodes are present.

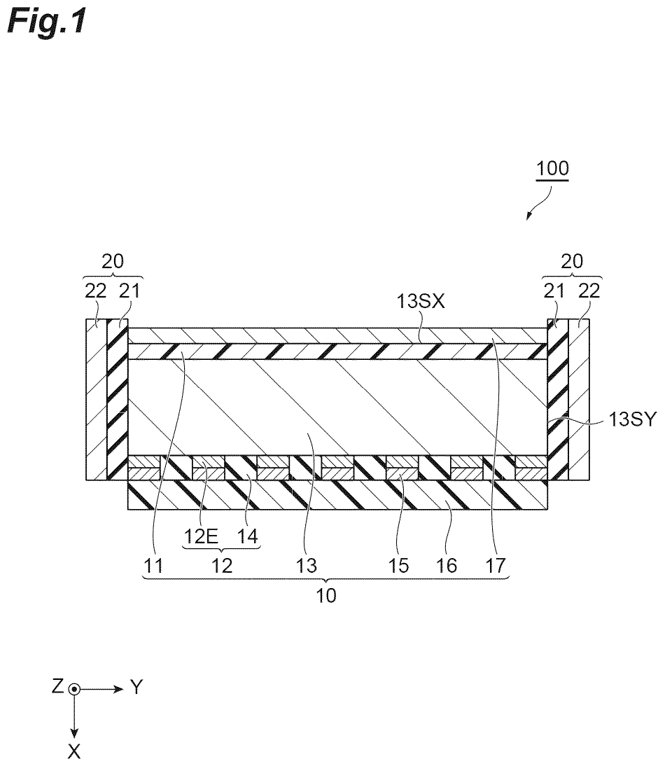

FIG. 1 is a schematic sectional view illustrating an embodiment of a radiation detector. A radiation detector 100 (hereinafter, also simply referred to as a “detector 100”) is a flat plate-like detector including a first electrode portion 11, a second electrode portion 12, a semiconductor crystal portion 13, an insulating portion 14, a connecting portion 15, a circuit board 16, a protective layer 17, an insulating layer 21, and a conductive layer 22. The semiconductor crystal portion 13 has two surfaces parallel to each other, and the first electrode portion 11 is formed on one surface of these surfaces, and the second electrode portion 12 is formed on the other surface.

The detector 100 includes a first portion 10 having the protective layer 17, the first electrode portion 11, the semiconductor crystal portion 13, the second electrode portion 12, the connecting portion 15, and the circuit board 16 in this order in an X direction. In the X direction, the first electrode portion 11 and the second electrode portion 12 face each other with the semiconductor crystal portion 13 interposed therebetween. The radiation detector may not include at least one selected from the group consisting of the protective layer, the connecting portion, and the circuit board. That is, the first portion of the radiation detector includes at least the first electrode portion, the semiconductor crystal portion, and the second electrode portion in this order.

The detector 100 includes a second portion 20 provided so as to surround a side surface 13SY (a surface parallel to the X direction) of the semiconductor crystal portion 13. The second portion 20 includes the insulating layer 21 and the conductive layer 22 in this order from the side surface 13SY of the semiconductor crystal portion 13 in directions (a Y direction and a Z direction) perpendicular to the X direction. The entire side surface of the first electrode portion 11 of the detector 100 is covered with the insulating layer 21, and the second portion 20 of the detector 100 includes the insulating layer 21 and the conductive layer 22 in this order from the side surface of the first electrode portion 11 in the directions perpendicular to the X direction. The first electrode portion may not be covered with the insulating layer, and the second portion may not have the insulating layer and the conductive layer in this order from the side surface of the first electrode portion.

One of the first electrode portion 11 and the second electrode portion 12 corresponds to an anode electrode, and the other corresponds to a cathode electrode. For example, in a case where the first electrode portion 11 is the cathode electrode, the second electrode portion 12 is the anode electrode.

Electrodes in the first electrode portion 11 and the second electrode portion 12 may have a metal layer containing at least one selected from the group consisting of a metal such as copper, gold, platinum, silver, thallium, nickel, or indium and an alloy containing these elements, and an underlayer containing at least one selected from the group consisting of a metal such as chromium, nickel, or bismuth and an alloy containing these elements. A thickness of the underlayer is, for example, 10 nm to 900 nm. In the electrodes in the first electrode portion 11 and the second electrode portion 12, a low-resistance metal layer made of a metal having a resistivity lower than that of the metal layer may be provided on the semiconductor crystal portion 13 side. The low-resistance metal layer may be, for example, a gold layer. A thickness of the low-resistance metal layer is, for example, 10 nm to 900 nm. An intermediate layer containing a metal such as chromium, nickel, or bismuth for enhancing adhesion between the low-resistance metal layer and the metal layer may be further provided between the low-resistance metal layer and the metal layer. A thickness of the intermediate layer is, for example, 1 nm to 900 nm. The underlayer, the low-resistance metal layer, and the intermediate layer may be vapor deposited films of metal. The electrodes in the first electrode portion 11 and the second electrode portion 12 may have, for example, the following stacked configuration.
Metal layer/low-resistance metal layer
Metal layer/intermediate layer/low-resistance metal layer
Underlayer/metal layer
Underlayer/metal layer/low-resistance metal layer
Underlayer/metal layer/intermediate layer/low-resistance metal layer

The first electrode portion 11 has one electrode (common electrode). The electrode in the first electrode portion 11 is electrically connected to a power supply. In a case where the first electrode portion 11 corresponds to the cathode electrode, carriers (holes) generated by an interaction between an incident radiation and the semiconductor crystal portion 13 are collected in the first electrode portion 11. In addition, in a case where the first electrode portion 11 is the cathode electrode, a voltage of −50 V to −1000 V may be applied to the electrode of the first electrode portion.

The first electrode portion 11 has a quadrilateral shape (square or rectangular) in plan view as viewed from the X direction. Lengths of the first electrode portion 11 in the Y direction and the Z direction may be, for example, 10 mm to 50 mm, respectively. A thickness (length in the X direction) of the first electrode portion 11 may be, for example, 10 nm to 10,000 nm.

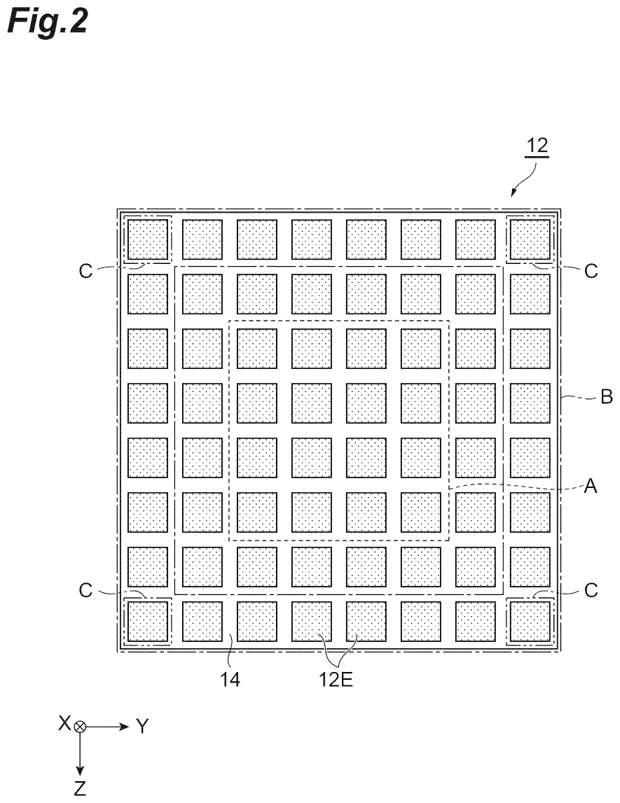

As illustrated in FIG. 2, the second electrode portion 12 includes a plurality of pixel electrodes 12E and the insulating portion 14. The plurality of pixel electrodes 12E are arrayed in the Y direction and the Z direction. The second electrode portion 12 includes the plurality of pixel electrodes 12E, and thus, energy resolution can be improved.

In a case where the second electrode portion 12 is the anode electrode, that is, in a case where the pixel electrode 12E is the anode electrode, the plurality of pixel electrodes 12E collect carriers (electrons) generated by an interaction between the incident radiation and the semiconductor crystal portion 13 in the second electrode portion 12.

The first electrode portion 11 and the second electrode portion 12 face each other. All of the plurality of pixel electrodes 12E face the first electrode portion 11 with the semiconductor crystal portion 13 interposed therebetween. At least one electrode of the plurality of pixel electrodes may face the first electrode portion.

The second electrode portion 12 has a quadrilateral shape (square or rectangular) in plan view from the X direction.

Each of the plurality of pixel electrodes 12E has a quadrilateral shape (square or rectangular) in plan view from the X direction.

The insulating portion 14 is provided to prevent electrical interference between the plurality of adjacent pixel electrodes 12E. Examples of the resin forming the insulating portion 14 include resin materials such as a silicone resin, an acrylic resin, a polyurethane resin, a polyimide resin, a polyolefin resin, and a fluororesin; and inorganic materials having insulating properties such as silicon oxide, silicon nitride, and aluminum oxide. From a viewpoint of sufficiently preventing the electrical interference between the plurality of adjacent pixel electrodes 12E, the insulating portion 14 may contain at least one selected from the group consisting of a silicone resin, an acrylic resin, a polyurethane resin, a polyimide resin, a polyolefin resin, and a fluororesin. The insulating portion 14 may be formed by a gap (air) instead of providing a member.

The semiconductor crystal portion 13 includes a semiconductor crystal that generates electrons and holes (carriers) by interacting with the incident radiation (X-rays, gamma rays, or the like). That is, the semiconductor crystal portion 13 includes a crystal containing a substance (compound semiconductor) that interacts with the incident radiation to generate the carriers. From a viewpoint of more excellent absorption efficiency of the radiation, the semiconductor crystal portion 13 may have a semiconductor crystal containing at least one selected from the group consisting of thallium bromide, cadmium telluride, cadmium zinc telluride, and lead cesium tribromide, and particularly may have a semiconductor crystal containing thallium bromide.

A content of thallium bromide in the semiconductor crystal of the semiconductor crystal portion 13 may be 80 mass % or more, 90 mass % or more, 95 mass % or more, or 98 mass % or more, or may be substantially 100 mass % (an aspect in which the semiconductor crystal is made of thallium bromide), based on a total mass of the semiconductor crystal, from a viewpoint of excellent absorption efficiency of the radiation.

A thickness (length in the X direction) of the semiconductor crystal portion 13 may be, for example, 0.5 mm to 10 mm.

The semiconductor crystal portion 13 may include one semiconductor crystal, or may include a plurality of semiconductor crystals from a viewpoint of being able to increase a detection area. That is, the radiation detector may include a semiconductor crystal portion having one semiconductor crystal for one second electrode portion, and may include a semiconductor crystal portion having a plurality of semiconductor crystals for one second electrode portion. The number of semiconductor crystals in a case where the semiconductor crystal portion includes the plurality of semiconductor crystals is not particularly limited, and the semiconductor crystal portion may include, for example, four semiconductor crystals or nine semiconductor crystals.

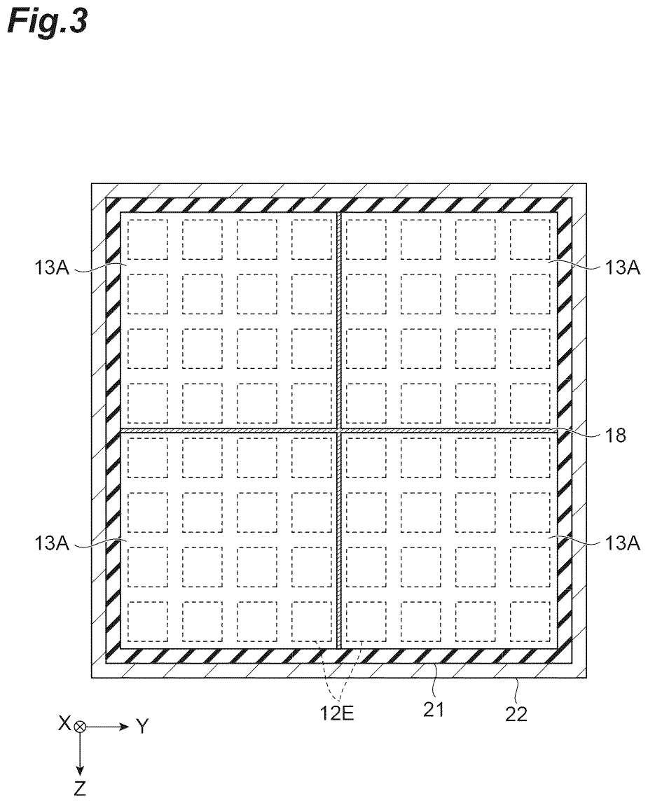

FIG. 3 illustrates a plan view in a case where the semiconductor crystal portion 13 includes the plurality of semiconductor crystals. In FIG. 3, the semiconductor crystal portion has four semiconductor crystals 13A and a resin layer 18. The resin layer 18 is provided at an interface between the semiconductor crystals 13A, and joins the semiconductor crystals 13A.

The four semiconductor crystals 13A have a substantially identical composition, and examples of the material constituting the semiconductor crystal 13A include thallium bromide, cadmium telluride, cadmium zinc telluride, and cesium lead tribromide. Thicknesses (lengths in the X direction) of the four semiconductor crystals 13A are substantially identical, and may be within a range of the thickness of the semiconductor crystal portion 13 described above.

The resin layer 18 is formed of, for example, a silicone resin, an acrylic resin, a polyurethane resin, a polyimide resin, a polyolefin resin, a fluororesin, or the like. The resin layer 18 may be made of, for example, Humiseal manufactured by ARBROWN Co., jp Ltd. A thickness (length in the X direction) of the resin layer 18 may be substantially identical to the thickness of the semiconductor crystal 13A. A width of the resin layer 18 (a length between the semiconductor crystals 13A; the length in the Y direction or the Z direction) may be, for example, 0.01 mm to 1 mm.

The connecting portion 15 electrically connects each of the plurality of pixel electrodes 12E of the second electrode portion 12 and the circuit board 16 to be described later. The connecting portion 15 is, for example, a conductive material such as solder or a conductive adhesive.

The circuit board (circuit unit) 16 includes a wiring pattern connected to the connecting portion 15 and a signal processing circuit. Examples of a material of the circuit board 16 include silicon, ceramic, quartz, glass, and plastic. For example, a glass composite substrate (CEM-3) obtained by impregnating a base material obtained by mixing a glass fabric and a glass nonwoven fabric with an epoxy resin, a glass epoxy substrate (FR-4) obtained by impregnating a glass fiber fabric with an epoxy resin, a metal heat dissipation substrate using copper, aluminum, or the like as a base material, or the like can be used as the circuit board 16. The signal processing circuit is, for example, an application specific integrated circuit (ASIC). The signal processing circuit processes carrier information (current value information) collected for each of the plurality of pixel electrodes 12E, and outputs, as radiological image data (data), the processed carrier information to a control unit. The signal processing circuit continuously or intermittently outputs the radiological image data to the control unit. The radiological image data may be a radiological image itself or data for generating a radiological image. The signal processing circuit may be provided on a substrate different from the circuit board 16.

The protective layer 17 protects the first electrode portion 11. The protective layer may be provided to protect not only the first electrode portion but also the second electrode portion, the conductive layer, the insulating layer, the substrate, and the like.

The protective layer 17 may be made of, for example, a material having insulating properties. Examples of the material having the insulating properties include resin materials such as a silicone resin, an acrylic resin, a polyurethane resin, a polyimide resin, a polyolefin resin, and a fluororesin; and inorganic materials having insulating properties such as silicon oxide, silicon nitride, and aluminum oxide.

A thickness (length in the X direction) of the protective layer 17 may be, for example, 0.1 mm to 2.0 mm. The thickness of the protective layer 17 is 0.5 mm or more, and thus, the first electrode portion 11 can be sufficiently protected.

The insulating layer 21 is provided so as to surround the side surface 13SY of the semiconductor crystal portion 13, and electrically insulates the semiconductor crystal portion 13 from the conductive layer 22. The insulating layer 21 may cover at least a part of the side surface 13SY of the semiconductor crystal portion 13, and may be formed to cover the entire side surface 13SY of the semiconductor crystal portion 13 from a viewpoint of further improving the energy resolution of the plurality of pixel electrodes 12E positioned in the outer peripheral portion and from a viewpoint of easily setting detection characteristics in the electrodes of the plurality of pixel electrodes 12E to be uniform.

As illustrated in FIG. 3, in a case where the semiconductor crystal portion includes the plurality of semiconductor crystals 13A, the insulating layer 21 is provided so as to surround not the side surface of each semiconductor crystal 13A but the side surface of the semiconductor crystal portion including the plurality of semiconductor crystals 13A. The insulating layer 21 may be formed not only on the side surface 13SY of the semiconductor crystal portion 13 but also on the side surface of the first electrode portion 11 and/or the second electrode portion 12.

The insulating layer 21 protrudes toward the first electrode portion 11 with respect to a plane including a surface 13SX of the semiconductor crystal portion 13 on the first electrode portion 11 side. The insulating layer 21 protrudes toward the first electrode portion 11 with respect to a plane including the surface 13SX of the semiconductor crystal portion 13 on the first electrode portion 11 side, and thus, a short circuit (discharge) between the electrode of the first electrode portion 11 and the conductive layer 22 can be reliably suppressed. In addition, in a case where the protective layer 17 is provided on the first electrode portion 11, the insulating layer 21 protrudes toward the first electrode portion 11 with respect to the plane including the surface 13SX of the semiconductor crystal portion 13 on the first electrode portion 11 side, and thus, in a case where a material forming the protective layer 17 is a liquid, a protruding portion of the insulating layer 21 suppresses the flowing of the material forming the protective layer 17 out to the side surface 13SY of the semiconductor crystal portion 13. As a result, when a plurality of radiation detectors are set to be adjacent to each other, the radiation detectors are easily arranged close to each other. The insulating layer 21 may protrude by 1 mm or more or may protrude by more than 0 mm and less than 1 mm with respect to the plane including the surface 13SX of the semiconductor crystal portion 13 on the first electrode portion 11 side. The insulating layer may not protrude toward the first electrode portion with respect to the plane including the surface of the semiconductor crystal portion on the first electrode portion side.

The insulating layer 21 is made of a material having insulating properties. Examples of a material for forming the insulating layer 21 include, for example, resin materials such as a silicone resin, an acrylic resin, a polyurethane resin, a polyimide resin, a polyolefin resin, and a fluororesin; and inorganic materials having insulating properties such as silicon oxide, silicon nitride, and aluminum oxide from a viewpoint of securing sufficient insulating properties. The insulating layer 21 may be formed by a gap (air). From a viewpoint of securing more sufficient insulating properties, the insulating layer 21 may contain at least one selected from the group consisting of a silicone resin, an acrylic resin, a polyurethane resin, a polyimide resin, a polyolefin resin, and a fluororesin.

A dielectric strength of the insulating layer 21 in a thickness direction may be, for example, 1 kV/mm or more, 1.5 kV/mm or more, 5 kV/mm or more, 10 kV/mm or more, 15 kV/mm or more, 19 kV/mm or more, 25 kV/mm or more from a viewpoint of securing sufficient insulating properties. An upper limit value of the dielectric strength of the insulating layer 21 in the thickness direction is not particularly limited, and may be, for example, 1000 kV/mm or less, or 500 kV/mm or less.

A withstand voltage of the insulating layer 21 in the thickness direction (direction perpendicular to the X direction) may be 0.01 kV or more, 0.1 kV or more, 0.5 kV or more, 0.9 kV or more, 1 kV or more, 2 kV or more, 4 kV or more, or 5 kV or more from a viewpoint of securing sufficient insulating properties. The withstand voltage of the insulating layer 21 in the thickness direction may be 20 kV or less, 15 kV or less, 10 kV or less, 8 kV or less, or 7 kV or less. The withstand voltage of the insulating layer 21 can be calculated by a product of the dielectric strength of the insulating layer 21 in the thickness direction and a thickness of the insulating layer 21.

The thickness of the insulating layer 21 (length in the direction perpendicular to the X direction) may be 300 μm or less, 200 μm or less, 150 μm or less, 100 μm or less, 80 μm or less, 50 μm or less, or 35 μm or less from a viewpoint of further improving the energy resolution of the plurality of pixel electrodes 12E positioned in the outer peripheral portion and from a viewpoint of easily uniformizing the detection characteristics in the electrodes of the plurality of pixel electrodes 12E. The thickness of the insulating layer 21 may be 10 μm or more, 20 μm or more, or 30 μm or more from a viewpoint of securing sufficient insulating properties. From these viewpoints, the thickness of the insulating layer 21 may be 10 μm to 300 μm, 20 μm to 200 μm, or 30 μm to 150 μm.

The conductive layer 22 is formed on the entire surface of the insulating layer 21. The detector 100 includes the conductive layer 22, and thus, it is presumed that an electric field intensity in the outer peripheral portion of the detector 100 becomes uniform and the energy resolution of the plurality of pixel electrodes 12E positioned in the outer peripheral portion can be improved. The conductive layer may be formed on a part of the surface of the insulating layer.

The conductive layer 22 is made of a material having sufficient conductivity. Examples of a material for forming the conductive layer 22, for example, metals such as copper, gold, platinum, silver, nickel, and indium, metal materials such as an alloy containing these elements; and carbon-containing materials such as carbon and conductive polymers from a viewpoint of securing sufficient conductivity. The conductive layer 22 may contain at least one selected from the group consisting of copper, aluminum, gold, and an alloy containing these elements from a viewpoint of being able to improve the energy resolution of the plurality of pixel electrodes 12E positioned in the outer peripheral portion.

A potential of the conductive layer 22 may be in a floating state. Since the potential of the conductive layer 22 is in the floating state, the energy resolution of the plurality of pixel electrodes 12E positioned in the outer peripheral portion can be further improved, and the detection characteristics of the electrodes of the plurality of pixel electrodes 12E can be easily set to be uniform. A potential may be applied to the conductive layer 22 in a non-floating state or may be at a ground potential.

The conductive layer 22 may be directly formed on the surface of the insulating layer 21 by vapor deposition or the like, or may be formed with an adhesive layer or the like interposed therebetween. In a case where the conductive layer 22 is formed on the surface of the insulating layer 21 with the adhesive layer interposed therebetween, the conductive layer 22 may be formed on the surface of the insulating layer 21 by using, for example, a conductive tape.

The conductive layer 22 protrudes toward the first electrode portion 11 with respect to the plane including the surface 13SX of the semiconductor crystal portion 13 on the first electrode portion 11 side. The conductive layer 22 may protrude by 1 mm or more or may protrude by more than 0 mm and less than 1 mm with respect to the plane including the surface 13SX of the semiconductor crystal portion 13 on the first electrode portion 11 side. From a viewpoint of reliably suppressing a short circuit (discharge) between the electrode of the first electrode portion and the conductive layer, the conductive layer may not protrude toward the first electrode portion with respect to the plane including the surface of the semiconductor crystal portion on the first electrode portion side. From a viewpoint of reliably uniformizing an electric field distribution in the semiconductor crystal portion, the conductive layer is preferably formed up to at least a position flush with the plane including the surface 13SX including the surface of the semiconductor crystal portion on the first electrode portion side. In addition, the conductive layer is preferably formed at a position not flush with the plane including the surface 13SX including the surface of the semiconductor crystal portion on the first electrode portion side (that is, the conductive layer is formed in a state of protruding or not protruding with respect to the first electrode) from a viewpoint of reliably suppressing a short circuit between the electrode of the first electrode portion and the conductive layer.

A thickness (length in the direction perpendicular to the X direction) of the conductive layer 22 may be 10 nm or more, 30 nm or more, 50 nm or more, 75 nm or more, 100 nm or more, or 150 nm or more from a viewpoint of further improving the energy resolution of the plurality of pixel electrodes 12E positioned in the outer peripheral portion and a viewpoint of easily uniformizing the detection characteristics in the electrodes of the plurality of pixel electrodes 12E, and may be 200 nm or more, 300 nm or more, or 400 nm or more from a viewpoint of further improving the energy resolution of the plurality of pixel electrodes 12E positioned in the outer peripheral portion. The thickness of the conductive layer 22 may be 1000 nm or less, 800 nm or less, 600 nm or less, or 500 nm or less from a viewpoint of securing sufficient conductivity. From these viewpoints, the thickness of the conductive layer 22 may be 10 nm to 1000 nm, 30 nm to 800 nm, or 50 nm to 600 nm.

The thickness of the conductive layer 22 is increased, and thus, among the plurality of pixel electrodes 12E, the pixel electrode positioned in the outer peripheral portion may be superior to the pixel electrode positioned in the central portion in terms of energy resolution. This is presumed to be because, in a case where the plurality of pixel electrodes 12E positioned in the outer peripheral portion and the plurality of pixel electrodes 12E positioned in the central portion have the same electric field intensity, the plurality of pixel electrodes 12E positioned in the outer peripheral portion are less likely to be influenced by noise from surrounding pixel electrodes because of the smaller number of adjacent pixel electrodes.

The radiation detector described above can be used in a radiation detection device, and more specifically, can be used in a single photon emission computed tomography device (SPECT), a positron emission tomography (PET) device, a gamma camera, a Compton camera, an imaging spectrometer, or the like.

According to the radiation detector described above, the energy resolution of the plurality of pixel electrodes 12E positioned in the outer peripheral portion can be improved. For this reason, the present inventors presume that the distribution of the electric field formed inside the semiconductor crystal portion 13 due to a potential difference applied between the first electrode portion 11 and the second electrode portion 12 is disturbed along an outer edge portion of the semiconductor crystal portion 13. That is, it was presumed that an equipotential surface parallel to one surface (YZ plane) of the semiconductor crystal portion 13 was formed in the central portion and had a uniform electric field distribution, whereas the equipotential surface was distorted outward and the electric field distribution became non-uniform in the vicinity of the outer edge portion of the semiconductor crystal portion 13. As a result of the non-uniform electric field distribution in the outer edge portion of the semiconductor crystal portion 13, even though carriers are generated in the semiconductor crystal portion 13 by the incident radiation, the collection efficiency of the carriers in the plurality of pixel electrodes 12E positioned in the outer peripheral portion decreases, and thus, the energy resolution is lower than that in the central portion. On the other hand, the insulating layer 21 and the conductive layer 22 are provided in this order on a side surface of a radiation detection element, the distortion of the electric field in the vicinity of the outer edge portion of the semiconductor crystal portion 13 is suppressed. Accordingly, it is presumed that since the electric field formed inside the semiconductor crystal portion 13 becomes uniform, a decrease in carrier collection efficiency in the plurality of pixel electrodes 12E positioned in the outer peripheral portion can be suppressed, and the energy resolution of the plurality of pixel electrodes 12E positioned in the outer peripheral portion can be improved.

In addition, according to the radiation detector described above, the energy resolution of the plurality of pixel electrodes 12E positioned in the outer peripheral portion is improved, and thus, the energy resolution of the entire multichannel detector is improved. Further, according to the radiation detector described above, since the energy resolution of each pixel electrode becomes uniform, it is possible to perform highly accurate imaging in a case where the radiation detector is applied to multiple simultaneous imaging in which radiations of different energies are simultaneously measured.

In a case where the radiation detector is used in the radiation detection device, the radiation detection device includes a power supply that applies a voltage to the radiation detector, and a control unit electrically connected to the radiation detector and the power supply, in addition to the radiation detector. That is, another embodiment of the present disclosure is a radiation detection device including the above-described radiation detector, a power supply that applies a voltage to the radiation detector, and a control unit electrically connected to the radiation detector and the power supply.

In the radiation detection device, the power supply applies a voltage to the radiation detector in accordance with a control signal from the control unit. The power supply applies, for example, a high voltage (HV) to the radiation detector. A voltage (ON voltage value) applied to the radiation detector by the power supply may be voluntarily set, and is, for example, −50 to −1000 V.

The control unit is electrically connected to the radiation detector and the power supply. The control unit includes, for example, a field-programmable gate array (FPGA). The control unit acquires radiographic image data output from the radiation detector and outputs the radiographic image data to a control device with an input and output interface interposed therebetween. The control unit may generate a radiological image based on the acquired radiological image data.

### EXAMPLES

Hereinafter, the present disclosure will be described more specifically with reference to examples. However, the present disclosure is not limited to these examples.

### Example 1

A stacked body including a common electrode made of a thallium alloy of 20 mm×20 mm×a thickness of 300 nm, a thallium bromide crystal (semiconductor crystal) having a thickness of 3 mm, a pixel electrode (the number of pixels: 8×8) made of a thallium alloy of 20 mm×20 mm×a thickness of 3 mm, and an ASIC in this order was produced on a circuit board.

A polyimide resin layer (Kapton tape, manufactured by DU PONT-TORAY CO., LTD., dielectric strength: 380 kV/mm) having a thickness of 150 μm was formed as an insulating layer so as to cover the entire side surface of the thallium bromide crystal of the produced stacked body. At this time, the insulating layer protruded by 0.5 mm with respect to a plane including a surface of the thallium bromide crystal on a common electrode side. Subsequently, a gold layer having a thickness of 0.3 μm was formed as a conductive layer on a surface of the polyimide resin layer by vapor deposition to obtain a radiation detector. At this time, the formed gold layer was in a floating state.

### Example 2

A radiation detector was obtained in the same manner as in Example 1 except that a thickness of the polyimide resin layer was changed to 80 μm.

### Example 3

A radiation detector was obtained in the same manner as in Example 1 except that a thickness of the polyimide resin layer was changed to 50 μm.

### Example 4

A radiation detector was obtained in the same manner as in Example 1 except that a thickness of the polyimide resin layer was changed to 35 μm.

### Comparative Example 1

A radiation detector was obtained in the same manner as in Example 1 except that the polyimide resin layer and the gold layer were not formed.

### Evaluation

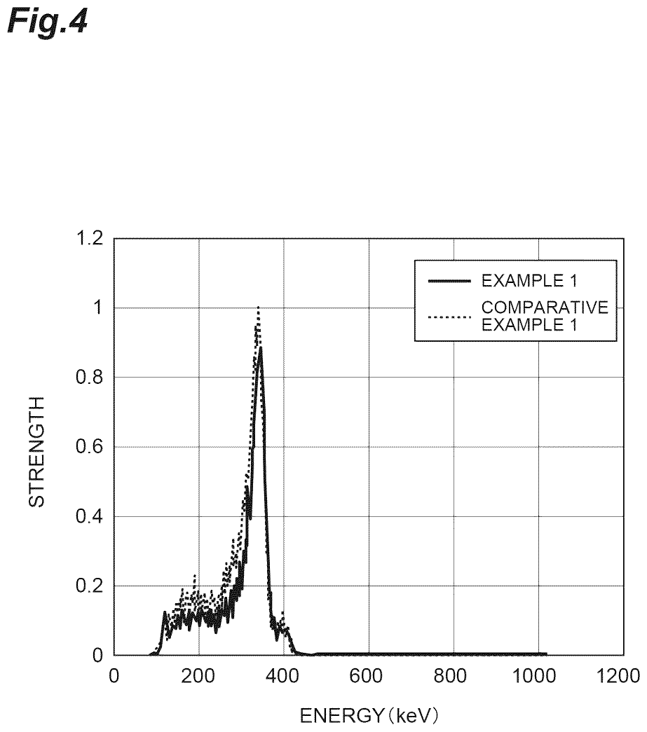

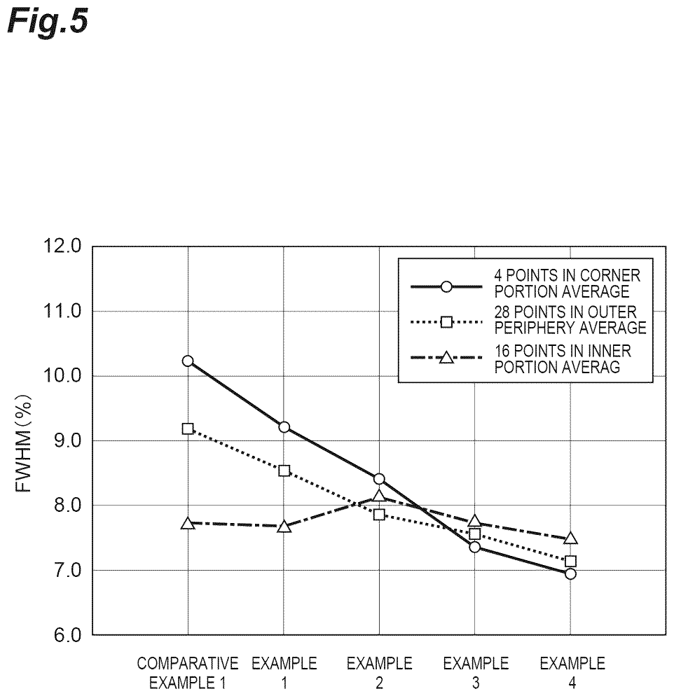

FIG. 4 illustrates results of energy spectra at one corner point of the pixel electrodes of Example 1 and Comparative Example 1. For Examples 1 to 4 and Comparative Example 1, an average value of the Full-width at Half-Maximum (FWHM) at 16 points in the central portion of the pixel electrode, an average value of the FWHM at 28 points in the outer edge portion, and an average value of the FWHM at 4 points in the corner portion are represented in Table 1 and FIG. 5. Note that the central portion of the pixel electrode is 16 pixel electrodes selected in descending order of distances from the center of the pixel electrode (region A in FIG. 2), the outer edge portion of the pixel electrode is 28 pixel electrodes selected in ascending order of distances from the center of the pixel electrode (region B in FIG. 2), and the corner portion of the pixel electrode is 4 pixel electrodes selected in descending order of distances from the center of the pixel electrode (region C in FIG. 2). The smaller the average value of the FWHM is, the better the energy resolution is. In addition, as the average value of the FWHM at 16 points in the central portion, the average value of the FWHM at 28 points in the outer edge portion, and the average value of the FWHM at 4 points in a corner portion are all substantially the same (within +1%), the detection characteristics (energy resolution) in the electrodes of the plurality of pixel electrodes mean to be uniform.

TABLE 1

| | | | | | | Comparative |
|---|---|---|---|---|---|---|
| | | Example 1 | Example 2 | Example 3 | Example 4 | Example 1 |
| Thickness of insulating layer [μm] | | 150 | 80 | 50 | 35 | — |
| Average | 16 points in central | 7.7 | 8.1 | 7.7 | 7.4 | 7.7 |
| value of | portion | | | | | |
| FWHM | 28 points in outer edge | 8.5 | 7.9 | 7.6 | 7.1 | 9.2 |
| [%] | portion | | | | | |
| | 4 points in corner | 9.2 | 8.4 | 7.4 | 7.0 | 10.2 |
| | portion | | | | | |

### Example 5

A radiation detector was obtained in the same manner as in Example 3 except that the insulating layer was formed so as to protrude 1.5 mm from the plane including the surface of the thallium bromide crystal on the common electrode side. The average value of the FWHM at 16 points in the central portion of the pixel electrode was 7.8%, the average value of the FWHM at 28 points in the outer edge portion was 7.4%, and the average value of the FWHM at 4 points in the corner portion was 7.4%.

### Example 6

A radiation detector was obtained in the same manner as in Example 4 except that the insulating layer was formed so as to protrude 1.5 mm from the plane including the surface of the thallium bromide crystal on the common electrode side. The average value of the FWHM at 16 points in the central portion of the pixel electrode was 7.8%, the average value of the FWHM at 28 points in the outer edge portion was 7.0%, and the average value of the FWHM at 4 points in the corner portion was 7.0%.

### Examples 7 to 11 and Comparative Examples 2 and 3

A radiation detector was obtained in the same manner as in Example 1 except that the insulating layer and the conductive layer were changed as represented in Table 2. The insulating layer and the insulating layer in the table mean to be made of the following materials, and “-” in a field of the conductive layer in Table 2 means that the conductive layer was not formed. In addition, in the evaluation field of Table 2, a case where the energy resolution of the outer peripheral portion (28 points in the outer edge portion and 4 points in the corner portion) of the radiation detector is similar to that of Example 1 is denoted as “A”, a case where the energy resolution is slightly inferior to that of Example 1 but superior to that of Comparative Example 1 is denoted as “B”, and a case where the energy resolution is similar to that of Comparative Example 1 is denoted as “C”.
Polyimide resin layer (Kapton tape manufactured by DU PONT-TORAY CO., LTD., thickness: 35 μm, dielectric strength: 380 kV/mm)
Fluororesin layer (VALFLON (registered trademark) manufactured by VALQUA, LTD., thickness: 50 μm, dielectric strength: 19 kV/mm)
Silicone resin layer (manufactured by Fuji Polymer Industries Co., Ltd., thickness: 250 μm, dielectric strength: 26 kV/mm)
Acrylic resin layer (Humiseal 1B66NS manufactured by ARBROWN Co., jp Ltd., thickness: 20 μm, dielectric strength: 22.4 kV/mm)
Aluminum layer (formed by vapor deposition, thickness: 0.3 μm)
Copper layer (manufactured by Terada seisakusho, trade name: 8323, copper tape, thickness: 70 μm)

TABLE 2

| | Insulating layer | Conductive layer | Evaluation |
|---|---|---|---|
| Example 7 | Polyimide resin layer | Aluminum layer | A |
| Example 8 | Polyimide resin layer | Gold layer | A |
| Example 9 | Polyimide resin layer | Copper layer | B |
| Example 10 | Fluororesin layer | Copper layer | B |
| Example 11 | Silicon resin layer | Copper layer | B |
| Comparative | Polyimide resin layer | — | C |
| Example 2 | | | |
| Comparative | Acrylic resin | — | C |
| Example 3 | | | |

### Examples 12 to 14

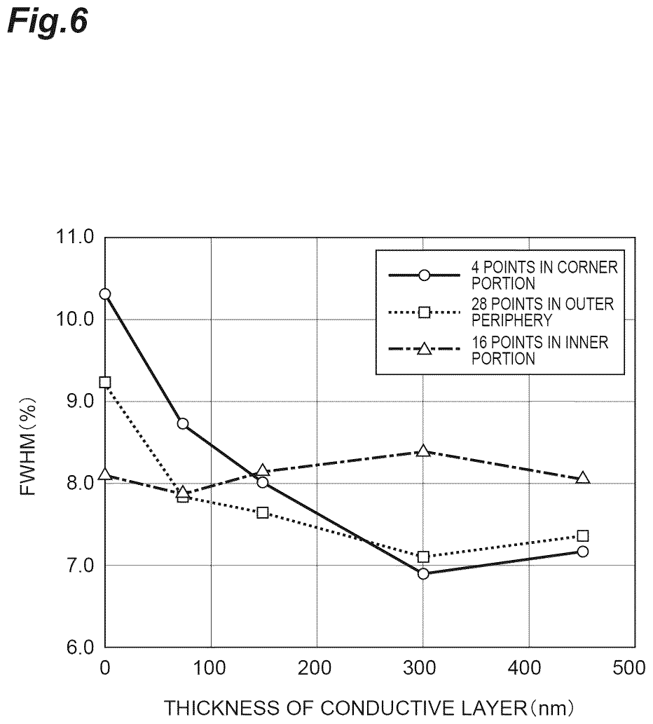

A radiation detector was obtained in the same manner as in Example 7 except that a thickness of the aluminum layer was changed as represented in Table 3. The average value of the FWHM at 16 points in the central portion of the pixel electrode, the average value of the FWHM at 28 points in the outer edge portion, and the average value of the FWHM at 4 points in the corner portion are represented in Table 3 and FIG. 6.

TABLE 3

| | | Example 7 | Example 12 | Example 13 | Example 14 |
|---|---|---|---|---|---|
| Thickness of conductive layer [nm] | | 300 | 75 | 150 | 450 |
| Average | 16 points in central | 8.4 | 7.9 | 8.1 | 8.0 |
| value of | portion | | | | |
| FWHM | 28 points in outer edge | 7.1 | 7.9 | 7.6 | 7.3 |
| [%] | portion | | | | |
| | 4 points in corner | 6.9 | 8.7 | 8.0 | 7.1 |
| | portion | | | | |

### REFERENCE SIGNS LIST

10 first portion
11 first electrode portion
12 second electrode portion
12E pixel electrode
13 semiconductor crystal portion
13A semiconductor crystal
13SX surface
13SY side surface
14 insulating portion
15 connecting portion
16 circuit board
17 protective layer
18 resin layer
20 second portion
21 insulating layer
22 conductive layer
100 radiation detector

What is claimed is:

1. A radiation detector comprising:
a first portion comprising a first electrode portion, a semiconductor crystal portion, and a second electrode portion facing the first electrode portion in this order; and
a second portion provided so as to surround a side surface of the semiconductor crystal portion,
wherein the second portion comprises an insulating layer and a conductive layer in this order from the side surface of the semiconductor crystal portion, and
the second electrode portion comprises a plurality of pixel electrodes.

2. The radiation detector according to claim 1, wherein the semiconductor crystal portion has a semiconductor crystal comprising at least one selected from the group consisting of thallium bromide, cadmium telluride, cadmium zinc telluride, and lead cesium tribromide.

3. The radiation detector according to claim 1, wherein the semiconductor crystal portion comprises a plurality of semiconductor crystals.

4. The radiation detector according to claim 1, wherein the insulating layer is disposed so as to cover entirety of the side surface of the semiconductor crystal portion.

5. The radiation detector according to claim 1, wherein the insulating layer protrudes toward the first electrode portion with respect to a plane comprising a surface of the semiconductor crystal portion on the first electrode portion side.

6. The radiation detector according to claim 1, wherein the insulating layer comprises at least one selected from the group consisting of a silicone resin, an acrylic resin, a polyurethane resin, a polyimide resin, a polyolefin resin, and a fluororesin.

7. The radiation detector according to claim 1, wherein a dielectric strength of the insulating layer in a thickness direction is 1.5 kV/mm or more.

8. The radiation detector according to claim 1, wherein a dielectric strength of the insulating layer in a thickness direction is 19 kV/mm or more.

9. The radiation detector according to claim 1, wherein a thickness of the insulating layer is 150 μm or less.

10. The radiation detector according to claim 1, wherein a thickness of the insulating layer is 50 μm or less.

11. The radiation detector according to claim 1, wherein the conductive layer comprises at least one selected from the group consisting of copper, aluminum, gold, and an alloy containing the copper, aluminum, or gold.

12. The radiation detector according to claim 1, wherein a thickness of the conductive layer is 50 nm or more.

13. The radiation detector according to claim 1, wherein a thickness of the conductive layer is 150 nm or more.

14. The radiation detector according to claim 1, wherein the second portion comprises the insulating layer and the conductive layer in this order from a side surface of the first electrode portion.

15. The radiation detector according to claim 1, further comprising:
a circuit unit electrically connected to each of the plurality of pixel electrodes,
wherein the circuit unit processes information collected for each of the plurality of pixel electrodes and outputs the processed information as data.

16. A radiation detection device comprising:
the radiation detector according to claim 1;
a power supply that applies a voltage to the radiation detector; and
a control unit electrically connected to the radiation detector and the power supply.

17. The radiation detection device according to claim 16, wherein a potential of the conductive layer is in a floating state.

18. The radiation detection device according to claim 16, wherein a potential of the conductive layer at a ground potential.
